(19) United States
(12) Patent Application Publication
(10) Pub. No.: US 2026/0320165 A1
(43) Pub. Date: Oct. 15, 2026

(54) Systems and Methods for Enforcing Risk-Based Authentication with Unified Identity Provider Data

(71) Applicant: Cisco Technology, Inc., San Jose, CA (US)

(72) Inventors: Alan I. Pinkert, West Lafayette, IN (US); Gillian V. Gacusan, Austin, TX (US); Kevin T. Burchfield, Lancaster, PA (US); Edgar Calderon Vaca, Fairfax, VA (US); Benjamin Wong, Houston, TX (US); Phillip Baker Schafer, Columbia, MD (US)

(21) Appl. No.: 19/177,182

(22) Filed: Apr. 11, 2025

(51) Int. Cl. G06F 21/31

(52) U.S. Cl. CPC G06F 21/316; G06F 2221/2101

(57) ABSTRACT

In one embodiment, a method includes collecting one or more access records associated with a user from one or more second Identity Providers (IdPs), where each of the one or more access records includes a log of an authentication attempt or a risk assessment, generating a consolidated set of access records associated with the user by processing the one or more access records, detecting one or more potential risks associated with the user in the one or more second IdPs based on the consolidated set of access records associated with the user, receiving an authentication request of the user for an application, evaluating context associated with the authentication request of the user based at least on the one or more potential risks associated with the user in the one or more second IdPs, and triggering an enforcement action corresponding to the evaluated context associated with the authentication request of the user.

### TECHNICAL FIELD

The present disclosure relates generally to identity and access management, and more particularly, to enforcing risk-based authentication with unified Identity Provider (IdP) data.

### BACKGROUND

As enterprise networks grow increasingly complex, organizations rely on IdPs to manage user authentication and enforce access control policies. An IdP is a trusted entity that verifies user identities and issues authentication tokens to enable access to applications and services. An enterprise network's identity and access management landscape may be composed of multiple IdPs that control access to many protected applications. Each of these IdPs may store data associated with access control policies and past user behavior, which may be used to provide context for future access requests. However, such data is siloed: IdPs in an enterprise network do not see data about each other's access requests or blend the identities of one provider with another. Thus, user behavior that is observed in one IdP and that could be considered risky by the one IdP does not affect the access requests for the same user in another IdP. Existing enterprise networks with multiple IdPs either force administrators to choose the enforcement actions best suited to mitigate risks or do not allow the authentication enforcement actions to be customized based on detected risks from other IdPs.

### BRIEF DESCRIPTION OF THE DRAWINGS

FIG. 1 illustrates an example flows for processing an access request to an application by an IdP.

FIG. 2 illustrates an example logical architecture of an enterprise network for enforcing risk-based authentication with unified IdP data.

FIG. 3 illustrates an example method for enforcing risk-based authentication with unified IdP data.

FIG. 4 illustrates an example computing system.

### DESCRIPTION OF EXAMPLE EMBODIMENTS

### Overview

In one or more embodiments, a method, by a system associated with a first IdP and communicatively connected with one or more second IdPs, may include collecting one or more access records associated with a user from the one or more second IdPs. Each of the one or more access records may comprise a log of an authentication attempt or a risk assessment. The method may include generating a consolidated set of access records associated with the user by processing the one or more access records. The method may include detecting one or more potential risks associated with the user in the one or more second IdPs based on the consolidated set of access records associated with the user. The method may include receiving an authentication request of the user for an application. The method may include evaluating context associated with the authentication request of the user based at least on the one or more potential risks associated with the user in the one or more second IdPs. The method may further include triggering an enforcement action corresponding to the evaluated context associated with the authentication request of the user.

In particular embodiments, a system associated with a first IdP and communicatively connected with one or more second IdPs may include one or more processors, and one or more computer-readable non-transitory storage media coupled to one or more of the processors. The one or more computer-readable non-transitory storage media may include instructions operable when executed by one or more of the processors to collect one or more access records associated with a user from the one or more second IdPs. Each of the one or more access records may comprise a log of an authentication attempt or a risk assessment. The processors are further operable when executing the instructions to generate a consolidated set of access records associated with the user by processing the one or more access records. The processors are further operable when executing the instructions to detect one or more potential risks associated with the user in the one or more second IdPs based on the consolidated set of access records associated with the user. The processors are further operable when executing the instructions to receive an authentication request of the user for an application. The processors are further operable when executing the instructions to evaluate context associated with the authentication request of the user based at least on the one or more potential risks associated with the user in the one or more second IdPs. The processors are further operable when executing the instructions to trigger an enforcement action corresponding to the evaluated context associated with the authentication request of the user.

In one or more embodiments, one or more computer-readable non-transitory storage media may embody software that is operable, when executed by a system associated with a first IdP and communicatively connected with one or more second IdPs, to collect one or more access records associated with a user from the one or more second IdPs. Each of the one or more access records may comprise a log of an authentication attempt or a risk assessment. The software may be further operable when executed by the system to generate a consolidated set of access records associated with the user by processing the one or more access records. The software may be further operable when executed by the system to detect one or more potential risks associated with the user in the one or more second IdPs based on the consolidated set of access records associated with the user. The software may be further operable when executed by the system to receive an authentication request of the user for an application. The software may be further operable when executed by the system to evaluate context associated with the authentication request of the user based at least on the one or more potential risks associated with the user in the one or more second IdPs. The software may be further operable when executed by the system to trigger an enforcement action corresponding to the evaluated context associated with the authentication request of the user.

In particular embodiments, a system may be associated with a first Identity Provider (IdP). The system may be communicatively connected with one or more second IdPs. The system may collect one or more access records associated with a user from the one or more second IdPs. Each of the one or more access records may include a log of an authentication attempt or a risk assessment. In particular embodiments, the system may use Application Programming Interfaces (APIs) provided by the one or more second IdPs to collect the one or more access records associated with the user from the one or more second IdPs. The system may generate a consolidated set of access records associated with the user by processing the one or more access records. In order to generate the consolidated set of access records, the system may map a second identifier corresponding to each of the one or more second IdPs with a first identifier corresponding to the first IdP. The system may further normalize a format of each of the one or more access records into a common format.

The system may detect one or more potential risks associated with the user in the one or more second IdPs based on the consolidated set of access records. In particular embodiments, the system may process the consolidated set of access records associated with the user with a machine learning model trained to predict a degree of a potential risk in each pre-identified risk category to detect the one or more potential risks associated with the user in the one or more second IdPs. In particular embodiments, the system may apply one or more heuristic detection algorithms to the consolidated set of access records associated with the user to detect the one or more potential risks associated with the user in the one or more second IdPs. In particular embodiments, the one or more heuristic detection algorithms may take a time of access, a client identifier used for accessing an application, Internet Protocol (IP) geolocation, or a Wi-Fi fingerprint from the one or more access records as input. In particular embodiments, the one or more heuristic detection algorithms detect a user-marked fraud, a push harassment, a push spray, an unrealistic travel, a country code mismatch, a novel autonomous system number (ASN), or an abnormal device distance.

In particular embodiments, the system may update access policies associated with the user at least based on the one or more potential risks associated with the user in the one or more second IdPs. The access policies may specify how long a device is remembered and set trusted networks to suppress unnecessary re-authentication prompts.

In particular embodiments, the system may receive an authentication request of the user for an application. The system may evaluate context associated with the authentication request of the user based at least on the one or more potential risks associated with the user in the one or more second IdPs. The system may trigger an enforcement action corresponding to the evaluated context associated with the authentication request of the user. In particular embodiments, the enforcement action may include setting a list of selectable authentication methods to those satisfying a level of security corresponding to the evaluated context. In particular embodiments, the enforcement action may include adapting a duration of a remembered device session for the user to a value corresponding to the evaluated context.

Technical advantages of certain embodiments of this disclosure may include one or more of the following. This disclosure describes systems and methods that generates a consolidated set of access requests associated with a user by processing one or more access records associated with the user collected from one or more IdPs. This disclosure also describes systems and methods that detecting one or more potential risks associated with a user in one or more IdPs based on the consolidated set of access records associated with the user. This disclosure further describes systems and methods that trigger an enforcement action corresponding to context associated with an authentication request of a user evaluated based on the one or more potential risks associated with the user in one or more other IdPs.

Other technical advantages will be readily apparent to one skilled in the art from the following figures, descriptions, and claims. Moreover, while specific advantages have been enumerated above, various embodiments may include all, some, or none of the enumerated advantages.

### Example Embodiments

An IdP plays several critical roles in an enterprise network by managing and verifying digital identities. The IdP may be responsible for confirming that users are who they claim to be as a part of an authentication process. The IdP performs user verification by verifying credentials (passwords, tokens, biometrics, etc.) before granting access to network resources. The IdP may support multi-factor authentication (MFA) to provide an extra layer of security, reducing the risk of unauthorized access. While authentication verifies identity, the IdP may also perform an authorization, which determines what an authenticated user is allowed to do. The IdP may help enforce policies that define user permissions and access levels. In particular embodiments, an IdP may also enable single sign-on (SSO), which allows users to log in once and access multiple applications without needing to re-enter credentials. SSO not only enhances user experience but also reduces the likelihood of password fatigue and associated security risks. Furthermore, an IdP may automate the creation, updating, and deletion of user accounts as employees join, change roles, or leave the organization. An IdP may maintain logs of authentication and access events, which are critical for security audits, compliance reporting, and forensic investigations in case of security breaches. An IdP may also enforce security policies, such as password complexity rules and session management policies, helping protect against unauthorized access and potential data breaches. Although this disclosure describes particular roles of an IdP in an enterprise network, this disclosure contemplates any suitable roles of an IdP in an enterprise network.

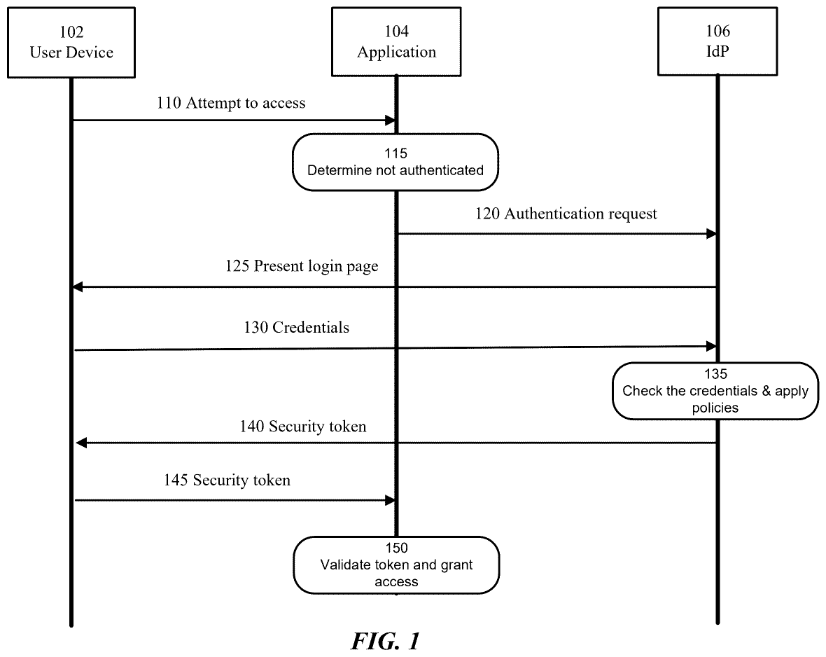

FIG. 1 illustrates an example flows for processing an access request to an application by an IdP. A user associated with a user device 102 may want to access an application 104. For example, the user may try to access the application 104 using a browser or a mobile app on the user device 102. At step 110, the user device 102 may attempt to access the application 104 in response to a user input. At step 115, the application may determine that the user is not authenticated based on a message received at step 110 and user status information stored in a database associated with the application 104. In response to the determination that the user is not authenticated, the application 104 may redirect the user's request to an IdP 106 with an authentication request at step 120. The redirection may use an authentication protocol, such as Security Assertion Markup Language (SAML) or OAuth 2.0/OpenID Connect (OIDC). At step 125, the IdP 106 may cause a login page to be presented on the user device 102. At step 130, the user may provide credentials on the login page, where the credentials may include username and password, MFA, or password-less login, such as biometric authentication. At step 135, the IdP 106 may check the received credentials by comparing with stored information. The IdP 106 may apply risk-based authentication and security policies while checking the received credentials. For example, the IdP 106 may check whether the user device 102 is known or managed by the enterprise network. The IdP 106 may also check whether the login attempt is made from an allowed geographic region. The IdP 106 may further determine whether the login matches the user's normal login pattern. If required, the IdP 106 may enforce additional verification step such as MFA. Once the authentication is successful at step 135, the IdP 106 may send a signed security token to the user device 102 at step 140. The security token may contain the user's authentication status and attributes. At step 145, the user device 102 may send the received signed security token to the application 104. The application, at step 150, may validate the signed security token. The validation may include verifying a digital signature of the security token using the IdP's public key. The validation may also include verifying an expiration time of the signed security token and scope permissions. Once the validation is successful, the application 104 may grant access to the user. Although this disclosure describes particular steps for processing an access request to an application by an IdP, this disclosure contemplates any suitable steps for processing an access request to an application by an IdP.

While a single IdP 106 may enforce an appropriate action based on information available to the IdP 106, the IdP 106 may not access data about other IdPs'access requests or blend the identities of other IdPs. Thus, the IdP 106 cannot be aware of user behavior that is observed in one IdP and that could be considered risky. This disclosure describes systems and methods for enforcing risk-based authentication with unified IdP data.

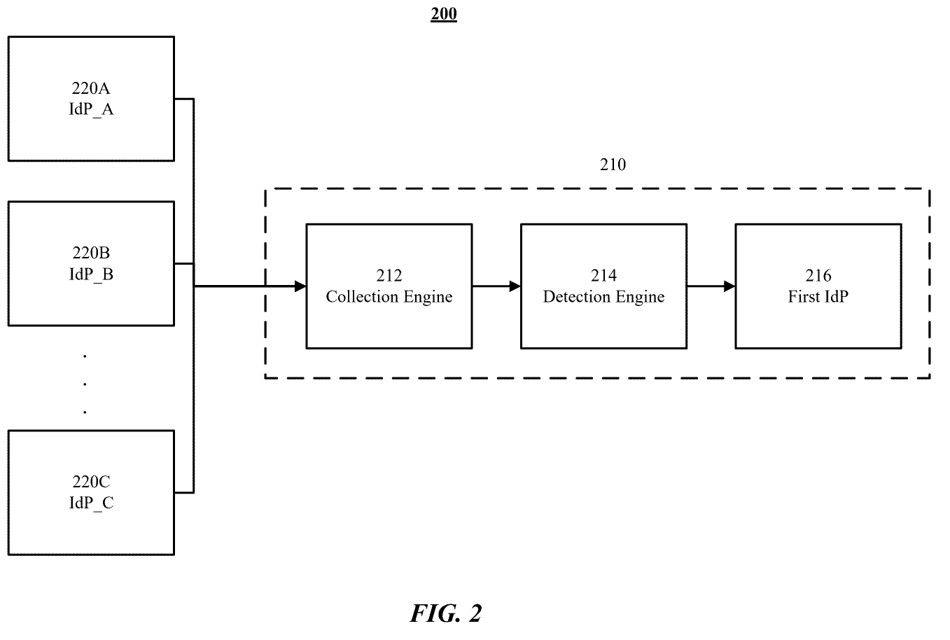

FIG. 2 illustrates an example logical architecture of an enterprise network 200 for enforcing risk-based authentication with unified IdP data. In particular embodiments, an enterprise network 200 may include a first IdP 216 and one or more second IdPs 220A-220C. In particular embodiments, a system 210 may be associated with the first IdP 216. The system may comprise a collection engine 212, a detection engine 214. The collection engine 212 of the system 210 may be communicatively connected with one or more second IdPs 220A-220C. In particular embodiments, the collection engine 212 and the detection engine 214 may be implemented on separate computing devices. In particular embodiments, the collection engine 212 or the detection engine 214 may be collocated with the first IdP 216. Although this disclosure describes a particular logical architecture of an enterprise network for enforcing risk-based authentication with unified IdP data, this disclosure contemplates any suitable logical architecture of an enterprise network for enforcing risk-based authentication with unified IdP data.

In particular embodiments, the system 210 may collect one or more access records associated with a user from the one or more second IdPs 220A-220C. Each of the one or more access records may include a log of an authentication attempt or a risk assessment. In particular embodiments, the system 210 may use Application Programming Interfaces (APIs) provided by the one or more second IdPs 220A-220C to collect the one or more access records associated with the user from the one or more second IdPs 220A-220C. As an example and not by way of limitation, a second IdP 220A may provide different APIs for accessing its data that the other second IdPs such as 220B or 220C. The collection engine 212 of the system 210 may be able to access the APIs provided by the second IdP 220A as well as APIs provided by the other second IdPs 220B and 220C to collect access records associated with users from each second IdP 220A, 220B, or 220C. When a new second IdP is deployed to the enterprise network, the collection engine 212 may be configured to access APIs provided by the new second IdP. In particular embodiments, the collection engine 212 may collect access records associated with users from the second IdPs 220A-220C at a pre-determined interval. In particular embodiments, the collection engine 212 may collect access records associated with users from the second IdPs 220A-220C in real-time. For the real-time collection, the collection engine 212 may establish and maintain a communication channel with each of the second IdPs 220A-220C such that the second IdP 220A, 220B, or 220C can push an access record to the collection engine 212 when the access record is generated. Although this disclosure describes collecting one or more access records associated with a user from one or more second IdPs in a particular manner, this disclosure contemplates collecting one or more access records associated with a user from one or more second IdPs in any suitable manner.

In particular embodiments, the system 210 may generate a consolidated set of access records associated with the user by processing the one or more access records collected from the one or more second IdPs 220A-220C. In order to generate the consolidated set of access records, the system 210 may map a second identifier corresponding to each of the one or more second IdPs 220A-220C with a first identifier corresponding to the first IdP 216. The system 210 may further normalize a format of each of the one or more access records into a common format. As an example and not by way of limitation, continuing with a prior example, each of the second IdPs 220A-220C may identify a user with different identifiers than the first IdP 216. For example, a user may be identified by an enterprise email address by the first IdP 216. The same user may be identified by a phone number by a second IdP 220A and by a messenger identifier by another second IdP 220B. The collection engine 212 of the system 210 may have mapping records to map a second identifier used by a second IdP 220A, 220B, or 220C into a first identifier used by the first IdP 216. When the collection engine 212 does not have a mapping record for a particular identifier, the collection engine 212 may take an action to correctly generate the mapping record for the particular identifier. The action may include prompting an administrator to complete the mapping record, prompting a corresponding user to complete or confirm the mapping record, or any other suitable action. Once the collection engine 212 collect an access record from a second IdP 220A, 220B, or 220C, which is associated with a particular identifier that is not compatible with the first IdP 216, the collection engine 212 may map the particular identifier into a first identifier compatible with the first IdP 216. As another example and not by way of limitation, continuing with a prior example, each of the second IdPs 220A-220C may have different record formats from each other as well as from the first IdP 216. The collection engine 212 may be configured to convert a record format of a second IdP 220A, 220B, or 220C into a pre-determined common format. When the collection engine 212 collects a particular access record that is not in the common format from a second IdP 220A, 220B, or 220C, the collection engine 212 may convert the format of the particular access record into the common format. Although this disclosure describes generating a consolidated set of access records associated with the user by processing the one or more access records collected from the one or more second IdPs in a particular manner, this disclosure contemplates generating a consolidated set of access records associated with the user by processing the one or more access records collected from the one or more second IdPs in any suitable manner.

In particular embodiments, the system 210 may detect one or more potential risks associated with the user in the one or more second IdPs 220A-220C based on the consolidated set of access records associated with the user. In particular embodiments, the system 210 may process the consolidated set of access records associated with the user with a machine learning model trained to predict a degree of a potential risk in each pre-identified risk category to detect the one or more potential risks associated with the user in the one or more second IdPs 220A-220C. In particular embodiments, the system 210 may process the consolidated set of access records associated with the user with a machine learning model trained to make a binary prediction whether the consolidated set of access records associated with the user is associated with a risk to detect the one or more potential risks associated with the user in the one or more second IdPs 220A-220C. As an example and not by way of limitation, continuing with a prior example, the detection engine 214 of the system 210 may receive the consolidated set of access records associated with the user from the collection engine 212. The detection engine 214 may utilize a multi-class classification machine learning model to determine one or more potential risks associated with the user in the one or more second IdPs 220A-220C. The multi-class classification machine learning model may take the consolidated set of access records associated with the user as input. The multi-class classification machine learning model may be trained to produce probabilities for pre-defined risk categories by processing the input data. In particular embodiments, the multi-class classification machine learning model may be implemented as a deep neural network (DNN), a Transformer neural network, a convolutional neural network (CNN), a recursive neural network (RNN), or in any suitable machine learning architecture. As another example and not by way of limitation, continuing with a prior example, the detection engine 214 may utilize a binary classification machine learning model to determine one or more potential risks associated with the user in the one or more second IdPs 220A-220C. The binary classification machine learning model may take the consolidated set of access records associated with the user as input. The binary classification machine learning model may be trained to produce a probability that the input consolidated set of access records associated with the user is associated with one or more risks by processing the input data. In particular embodiments, the binary classification machine learning model may be implemented as a deep neural network (DNN), a Transformer neural network, a convolutional neural network (CNN), a recursive neural network (RNN), or in any suitable machine learning architecture. Although this disclosure describes detecting one or more potential risks associated with the user in the one or more second IdPs using a machine learning model in a particular manner, this disclosure contemplates detecting one or more potential risks associated with the user in the one or more second IdPs using a machine learning model in any suitable manner.

In particular embodiments, the system 210 may apply one or more heuristic detection algorithms to the consolidated set of access records associated with the user to detect the one or more potential risks associated with the user in the one or more second IdPs 220A-220C. In particular embodiments, the one or more heuristic detection algorithms may take a time of access, a client identifier used for accessing an application, Internet Protocol (IP) geolocation, or a Wi-Fi fingerprint from the one or more access records as input. In particular embodiments, the one or more heuristic detection algorithms detect a user-marked fraud, a push harassment, a push spray, an unrealistic travel, a country code mismatch, a novel autonomous system number (ASN), or an abnormal device distance. A user-marked fraud is a case where the user has indicated that the user was not responsible for an attempted login as a response to a login confirmation request sent by an IdP. A push harassment is a type of attack where a malicious actor repeatedly sends push notifications to the user's device. The push notifications may be an approval request for a login attempt. Such attacks may annoy the user and make the user approve a login attempt simply to stop the notifications. A push spray is a type of attack that attempts to gain access to multiple users at once through push notifications. A malicious actor may send a large number of push notifications to multiple users. A user may be confused or frustrated by the barrage of notifications and tricked into approving an unauthorized access attempt. An unrealistic travel may be detected when a user attempts to authenticate from a new location that would be impossible to reach based on the past authentication time and location. A country code mismatch occurs when an authentication device and an access device appear to be in two different countries. A novel ASN is detected when a user attempts to authenticate from an ASN not seen in the recent history of successful authentication for the organization. An abnormal device distance is detected when an authentication device and an access device are abnormally far from each other. As an example and not by way of limitation, the detection engine 214 may observe that a user recently indicated a user-marked fraud in an access record from a second IdP 220A, 220B, or 220C. The detection engine 214 may consider that the user may be associated with a potential high risk. As another example and not by way of limitation, the detection engine 214 may observe that an access record associated with a user from a second IdP 220A, 220B, or 220C indicates that a country code mismatch occurs for a recent authentication attempt from the user. The detection engine 214 may consider that the user may be associated with a potential high risk. Although this disclosure describes detecting one or more potential risks associated with a user in the one or more second IdPs by applying one or more heuristic detection algorithms to the consolidated set of access records associated with the user in a particular manner, this disclosure contemplates detecting one or more potential risks associated with a user in the one or more second IdPs by applying one or more heuristic detection algorithms to the consolidated set of access records associated with the user in any suitable manner.

In particular embodiments, the system 210 may update access policies associated with the user for the first IdP 216 at least based on the one or more potential risks associated with the user in the one or more second IdPs 220A-220C. The access policies may specify how long a device is remembered and set trusted networks to suppress unnecessary re-authentication prompts. As an example and not by way of limitation, continuing with a prior example, the access policies for a user in the first IdP 216 allow to remember a device of the user for 24 hours. Thus, once the device associated with the user is authenticated, the device does not need to be re-authenticated for the next 24 hours. The first IdP 216 may access the one or more detected potential risks associated with the user in the one or more second IdPs 220A-220C. The first IdP 216 may change the access policies for the user such that a device associated with the user is not remembered. With the updated access policies, whenever the device associated with the user attempts to access one or more applications associated with the first IdP 216, the device is required to be authenticated. In particular embodiments, the detection engine 214 may be collocated with the first IdP 216. In particular embodiments, the detection engine 214 may be deployed on a computing device separate from a computing device the first IdP 216 is deployed on. Although this disclosure describes updating access policies associated with a user for a first IdP based on one or more detected potential risks associated with the user in one or more second IdPs in a particular manner, this disclosure contemplates updating access policies associated with a user for a first IdP based on one or more detected potential risks associated with the user in one or more second IdPs in any suitable manner.

In particular embodiments, the system 210 may receive an authentication request of the user for an application. As an example and not by way of limitation, continuing with a prior example, a user attempts to access an application associated with the first IdP 216. The application may forward an authentication request to the first IdP 216 as shown at step 120 in FIG. 1. The authentication request message may be a SAML-compatible message or an OIDC-compatible message. Although this disclosure describes receiving an authentication request message of a user for an application associated with a first IdP in a particular manner, this disclosure contemplates receiving an authentication request message of a user for an application associated with a first IdP in any suitable manner.

In particular embodiments, the system 210 may evaluate context associated with the authentication request of the user based at least on the one or more potential risks associated with the user in the one or more second IdPs. In particular embodiments, the system 210 may evaluate context associated with the authentication request of the user based on the consolidated set of access records associated with the user. As an example and not by way of limitation, continuing with a prior example, the first IdP 216 may determine that the user recently attempted to access a second application associated with one of the second IdPs 220A-220C from a first geographic location based on a wi-fi fingerprint in one of the consolidated access records associated with the user. The first IdP 216 may determine that the authentication request of the user for the application is made from a second geographic location based on an IP geolocation from which the user is attempting to access the application. The first IdP 216 may determine that travelling from the first geographic location to the second geographic location in a time duration between two access attempts is unreasonable. The first IdP may apply any available heuristic algorithm to evaluate the context associated with the authentication request of the user based on the one or more potential risks associated with the user in the one or more second IdPs or based on the consolidated set of access records associated with the user. As another example and not by way of limitation, the first IdP 216 may evaluate context associated with the authentication request using a machine learning model. In particular embodiments, the first IdP 216 may provide the records associated with the one or more detected potential risks associated with the user in the one or more second IdPs and information associated with the authentication request as input. In particular embodiments, the first IdP 216 may provide the consolidated access records and information associated with the authentication request as input. In particular embodiments, the first IdP 216 may provide the consolidated access records, the records associated with the one or more detected potential risks associated with the user in the one or more second IdPs, and information associated with the authentication request as input. The machine learning model may produce a probability of the authentication request being malicious when the machine learning model is a binary classification model. When a multi-class classification machine learning model is used, the machine learning model may produce probabilities corresponding to pre-defined risk categories associated with the authentication request. Although this disclosure describes evaluating context associated with the authentication request of the user based on information collected from one or more second IdPs in a particular manner, this disclosure contemplates evaluating context associated with the authentication request of the user based on information collected from one or more second IdPs in any suitable manner.

In particular embodiments, the system 210 may trigger an enforcement action corresponding to the evaluated context associated with the authentication request of the user. In particular embodiments, the enforcement action may include setting a list of selectable authentication methods to those satisfying a level of security corresponding to the evaluated context. In particular embodiments, the enforcement action may include adapting a duration of a remembered device session for the user to a value corresponding to the evaluated context. As an example and not by way of limitation, continuing with a prior example, some authentication factors, such as push notifications or platform authenticators, may have stronger security properties than weaker factors, such as short message service (SMS). Upon the first IdP 216 determines that the evaluated context associated with the authentication request of a user indicates that the authentication request of the user might be risky, the first IdP 216 may enforce the user to authenticate with stronger authentication factors rather than weaker factors. As another example and not by way of limitation, a user may have a remembered session, during which authentications for access attempts from the same device may be skipped. When the first IdP 216 determines that the evaluated context associated with the authentication request of a user indicates that the authentication request of the user might be risky, the first IdP 216 may terminate the remembered session such that any access attempt to an application associated with the first IdP 216 may require to be authenticated via one or more stronger authentication factors. In particular embodiments, the first IdP 216 may determine an appropriate enforcement action based on the evaluated context associated with the authentication request of the user. Although this disclosure describes triggering an enforcement action corresponding to evaluated context associated with an authentication request of a user in a particular manner, this disclosure contemplates triggering an enforcement action corresponding to evaluated context associated with an authentication request of a user in any suitable manner.

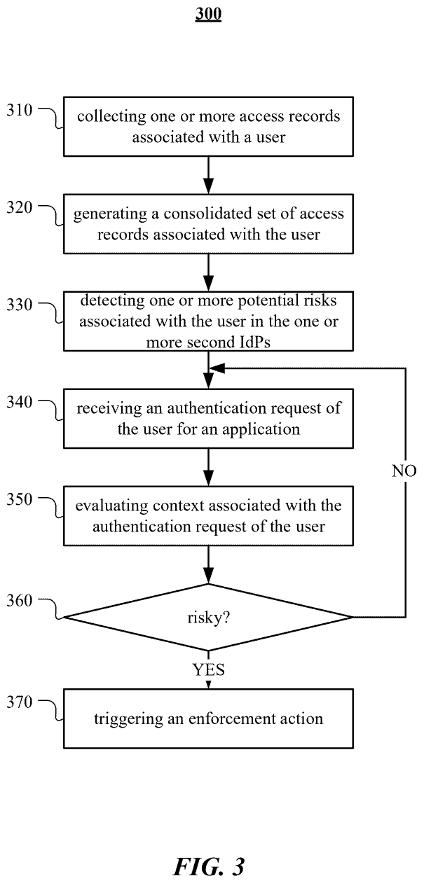

FIG. 3 illustrates an example method 300 for enforcing risk-based authentication with unified IdP data. The method may begin at step 310, where a system associated with a first IdP and communicatively connected with one or more second IdPs may collect one or more access records associated with a user from the one or more second IdPs. Each of the one or more access records may comprise a log of an authentication attempt or a risk assessment. At step 320, the system may generate a consolidated set of access records associated with the user by processing the one or more access records. At step 330, the system may detect one or more potential risks associated with the user in the one or more second IdPs based on the consolidated set of access records associated with the user. At step 340, the system may receive an authentication request of the user for an application. At step 350, the system may evaluate context associated with the authentication request of the user based at least on the one or more potential risks associated with the user in the one or more second IdPs. When the system determines that the context associated with the authentication request of the user is associated with a potential risk at step 360, the method proceeds to step 370, where the system may trigger an enforcement action corresponding to the evaluated context associated with the authentication request of the user. When the system determines that the context associated with the authentication request of the user is not associated with a potential risk at step 360, the system may process the authentication request of the user and wait a next authentication request.

Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for enforcing risk-based authentication with unified IdP data of the method of FIG. 3, this disclosure contemplates any suitable method for enforcing risk-based authentication with unified IdP data including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

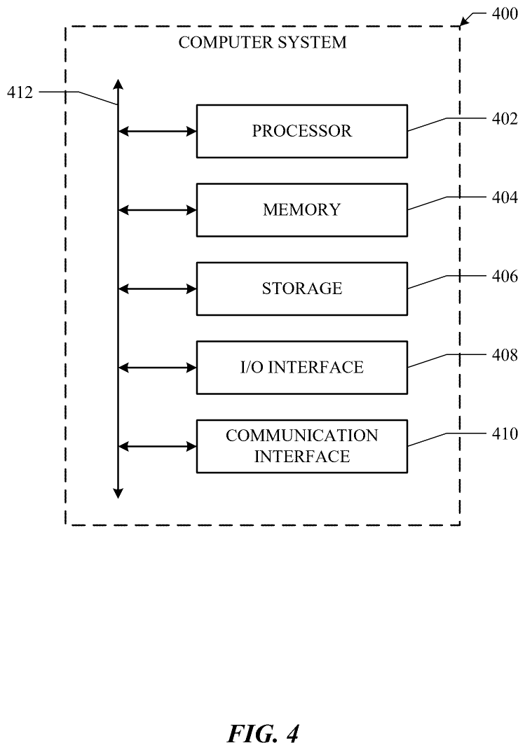

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a system associated with a first Identity Provider (IdP) and communicatively connected with one or more second IdPs:
collecting, from the one or more second IdPs, one or more access records associated with a user, wherein each of the one or more access records comprises a log of an authentication attempt or a risk assessment;
generating a consolidated set of access records associated with the user by processing the one or more access records;
detecting, based on the consolidated set of access records associated with the user, one or more potential risks associated with the user in the one or more second IdPs;
receiving an authentication request of the user for an application;
evaluating context associated with the authentication request of the user based at least on the one or more potential risks associated with the user in the one or more second IdPs; and
triggering an enforcement action corresponding to the evaluated context associated with the authentication request of the user.

2. The method of claim 1, wherein processing of the one or more access records comprises mapping a second identifier corresponding to each of the one or more second IdPs with a first identifier corresponding to the first IdP.

3. The method of claim 1, wherein processing of the one or more access records comprises normalizing a format of each of the one or more access records into a common format.

4. The method of claim 1, wherein the detecting the one or more potential risks associated with the user in the one or more second IdPs comprises processing the consolidated set of access records associated with the user with a machine learning model trained to predict a degree of a potential risk in each pre-identified risk category.

5. The method of claim 1, wherein the detecting the one or more potential risks associated with the user in the one or more second IdPs comprises applying one or more heuristic detection algorithms to the consolidated set of access records associated with the user.

6. The method of claim 5, wherein the one or more heuristic detection algorithms takes a time of access, a client identifier used for accessing an application, Internet Protocol (IP) geolocation, or a Wi-Fi fingerprint from the one or more access records as input.

7. The method of claim 5, wherein the one or more heuristic detection algorithms detect a user-marked fraud, a push harassment, a push spray, an unrealistic travel, a country code mismatch, a novel autonomous system number (ASN), or an abnormal device distance.

8. The method of claim 1, wherein the enforcement action comprises setting a list of selectable authentication methods to those satisfying a level of security corresponding to the evaluated context.

9. The method of claim 1, wherein the enforcement action comprises adapting a duration of a remembered device session for the user to a value corresponding to the evaluated context.

10. The method of claim 1, further comprising:
updating access policies associated with the user at least based on the one or more potential risks associated with the user in the one or more second IdPs.

11. The method of claim 10, wherein the access policies specify how long a device is remembered and set trusted networks to suppress unnecessary re-authentication prompts.

12. The method of claim 1, wherein collecting the one or more access records associated with the user from the one or more second IdPs is done via using Application Programming Interfaces (APIs) provided by the one or more second IdPs.

13. A system associated with a first Identity Provider (IdP) and communicatively connected with one or more second IdPs comprising:
one or more processors; and
one or more computer-readable non-transitory storage media coupled to one or more of the processors and comprising instructions operable when executed by one or more of the processors to:
collect, from the one or more second IdPs, one or more access records associated with a user, wherein each of the one or more access records comprises a log of an authentication attempt or a risk assessment;
generate a consolidated set of access records associated with the user by processing the one or more access records;
detect, based on the consolidated set of access records associated with the user, one or more potential risks associated with the user in the one or more second IdPs;
receive an authentication request of the user for an application;
evaluate context associated with the authentication request of the user based at least on the one or more potential risks associated with the user in the one or more second IdPs; and
trigger an enforcement action corresponding to the evaluated context associated with the authentication request of the user.

14. The system of claim 13, wherein processing of the one or more access records comprises mapping a second identifier corresponding to each of the one or more second IdPs with a first identifier corresponding to the first IdP.

15. The system of claim 13, wherein processing of the one or more access records comprises normalizing a format of each of the one or more access records into a common format.

16. The system of claim 13, wherein the detecting the one or more potential risks associated with the user in the one or more second IdPs comprises processing the consolidated set of access records associated with the user with a machine learning model trained to predict a degree of a potential risk in each pre-identified risk category.

17. The system of claim 13, wherein the detecting the one or more potential risks associated with the user in the one or more second IdPs comprises applying one or more heuristic detection algorithms to the consolidated set of access records associated with the user.

18. One or more computer-readable non-transitory storage media embodying software that is operable when executed by a system associated with a first Identity Provider (IdP) and communicatively connected with one or more second IdPs to:
collect, from the one or more second IdPs, one or more access records associated with a user, wherein each of the one or more access records comprises a log of an authentication attempt or a risk assessment;
generate a consolidated set of access records associated with the user by processing the one or more access records;
detect, based on the consolidated set of access records associated with the user, one or more potential risks associated with the user in the one or more second IdPs;
receive an authentication request of the user for an application;
evaluate context associated with the authentication request of the user based at least on the one or more potential risks associated with the user in the one or more second IdPs; and
trigger an enforcement action corresponding to the evaluated context associated with the authentication request of the user.

19. The media of claim 18, wherein processing of the one or more access records comprises mapping a second identifier corresponding to each of the one or more second IdPs with a first identifier corresponding to the first IdP.

20. The media of claim 18, wherein processing of the one or more access records comprises normalizing a format of each of the one or more access records into a common format.
